(19) United States
(12) Patent Application Publication
(10) Pub. No.: US 2015/0185079 A1
(43) Pub. Date: Jul. 2, 2015

(54) Hyper-Spectral and Hyper-Spatial Search, Track and Recognition Sensor

(71) Applicant: ISC8 Inc., Costa Mesa, CA (US)

(72) Inventors: James Justice, Newport Beach, CA (US); John Carson, Corona del Mar, CA (US); Medhat Azzazy, Laguna Niguel, CA (US); David Ludwig, Irvine, CA (US)

(21) Appl. No.: 13/948,766

(22) Filed: Jul. 23, 2013

Related U.S. Application Data
(63) Continuation-in-part of application No. 12/924,141, filed on Sep. 20, 2010, now abandoned.
Application No. 12/924,141 is a continuation of application No. 13/338,332, filed on Dec. 28, 2011, now abandoned.
Application No. 13/338,332 is a continuation-in-part of application No. 13/338,328, filed on Dec. 28, 2011, now abandoned.
Application No. 13/338,328 is a continuation-in-part of application No. 12/661,537, filed on Mar. 18, 2010, now Pat. No. 8,510,244.
(60) Provisional application No. 61/674,416, filed on Jul. 23, 2012.

(51) Int. Cl. G01J 3/28; G01N 21/84

(52) U.S. Cl. CPC G01J 3/2803; G01N 21/84

(57) ABSTRACT

A hyper-spectral and hyper-spatial sensor system is disclosed. A micro-channel plate array imaging sensor is provided for imaging a scene of interest and cooperates with a passive imaging system which may comprise a system having a responsivity to the visible electromagnetic spectrum. Image data from the dual-sensor systems is received and processed at high processing speeds using a massively parallel image processing architecture for the detection of salient scene features in the scene.

### CROSS-REFERENCE TO RELATED APPLICATIONS

Tills application claims the benefit of U.S. Provisional Patent Application No. 61/674,416, filed on Jul. 23, 2012, entitled “Hyper-Spectral and Hyper-Spatial Search, Track and Recognition Sensor” pursuant to 35 USC 119, which application is incorporated folly herein by reference.

This application is a continuation-in-part application of U.S. patent application Ser. No. 12/924,141 entitled “Mufti-Layer Photon Counting Electronic Module”, filed on Sep. 20, 2010, which in turn claims priority to U.S. Provisional Patent Application No. 61/277,360, entitled “Three-Dimensional Multi-Level Logic Cascade Counter”, filed on Sep. 22, 2009, pursuant to 35 USC 119, which applications are incorporated fully herein by reference.

This application is a continuation-in-part application of U.S. patent application Ser. No. 13/338,332 entitled “Sensor System Comprising Stacked Micro-Channel Plate Detector”, filed on Dec. 28, 2011, which in turn claims priority to U.S. Provisional Patent Application No. 61/460,173, entitled “Micro-Channel Plate Assembly for Use with, an Electronic Imaging Device”, filed on Dec. 28, 2010, pursuant to 35 USC 119, which applications are incorporated fully herein by reference.

This application is a continuation-in-part application of U.S. patent application Ser. No. 13/338,328 entitled “Stacked Micro-Channel Plate Assembly Comprising a Micro-Lens”, filed on Dec. 28, 2011, which in turn claims priority to U.S. Provisional Patent Application No. 61/460,173, entitled “Micro-Channel Plate Assembly for Use with, an Electronic Imaging Device”, filed on Dec. 28, 2010, pursuant to 35 USC 119, which applications are incorporated folly herein by reference.

This application is a continuation-in-part application of U.S. patent application Ser. No. 12/661,537 entitled. “Apparatus Comprising Artificial Neuronal Assembly”, filed on Mar. 18, 2010, which in turn claims priority to U.S. Provisional Patent Application No. 61/210,565, entitled “Apparatus Comprising Artificial Neuronal Assembly”, filed on Mar. 20, 2009, and U.S. Provisional Patent Application No. 61/268,659 entitled “Massively Interconnected Synapse Neuron Assemblies and Method for Making Same”, filed on Jun. 15, 2009, pursuant to 35 USC 119, winch applications are incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of electronic sensor systems. More specifically, the invention relates to a hyper-spectral and hyper-spatial search, track and recognition sensor system for use in, for instance, real-time detection and recognition of improvised, explosive devices (“IEDs”) on last moving vehicles for damage avoidance.

2. Description of the Related Art

Timely and effective IED detection, and recognition on fast moving vehicles requires sensor suite operation based on multiple phenomenologies operating at extended ranges with extensive real-time data processing and operator display to support IED damage avoidance.

Explosive devices that pose significant threats to in-theatre military personnel and vehicles are particularly those that are buried or only partially-exposed. These buried explosives are difficult to detect or to identify rapidly, yet possess a broad spectrum of physical characteristics and observables that, in combination, can form the basis of detection and recognition solutions.

Observables may include disturbed earth texture associated with, buried explosives, thermal scars, partially-exposed wires, small exposed component features, or unique physical material characteristics of various metals, plastics, and explosive constituents.

Detection and recognition of these observables must be made within a relatively short timeline (e.g., six seconds or less) to permit a high-speed vehicle sufficient time to stop outside of the “kill radius” of the device.

The increasingly complex and evolving IED threat is thus increasing the need for higher resolutions in spatial, temporal and spectral domains in sensing systems to ensure confident and timely detection and recognition of IEDs. Further, these performance requirements must be achieved at extended ranges if rapidly moving vehicles are to be kept out of harm's way.

What is needed to address the above problem is a sensor system for the detection of a plurality of physical characteristics of an IED and to identify its location to permit early detection and avoidance.

### BRIEF SUMMARY OF THE INVENTION

A hyper-spectral and hyper-spatial sensor system, is disclosed.

A micro-channel plate array imaging sensor is provided for actively and using a plurality of electromagnetic spectra, (i.e., hyper-spectral) imaging a scene of interest such as by UV laser and cooperates with a passive imaging system which may comprise a system having a responsivity to the visible electromagnetic spectrum.

Image data from the above dual-sensor systems is received and processed at high processing speeds using a massively parallel image processing architecture for the detection of salient scene features which may comprise an improvised explosive device or IED.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 shows a flow diagram of a preferred embodiment of a salieacy algorithm architecture of the invention.

FIG. 2 shows a block diagram, of a preferred embodiment of the sensor suite of the invention.

FIG. 3 is a view of a preferred embodiment of a micro-channel plate sensor assembly and stacked ROIC for use in a preferred embodiment of the invention.

FIG. 4 is a block diagram of a main-tiered ROIC image processing element of FIG. 3 for use in a preferred, embodiment of the invention.

FIGS. 5 and 6 depict block diagrams of a preferred embodiment of a massively parallel image processing element for use in a preferred embodiment of the invention.

FIG. 7 depicts a sensor simulation/emulation flowchart for use in emulating the sensor system of the invention.

The invention and its various, embodiments can now be better understood by turning to the following detailed description of the preferred embodiments which are presented as illustrated examples of the invention defined in the claims.

It is expressly understood that the invention as defined by the claims may be broader titan the illustrated, embodiments described below.

### DETAILED DESCRIPTION OF THE INVENTION

Turning now to the figures wherein like references define like elements among the several views, Applicant discloses a hyper-spectral and hyper-spatial search, track and recognition sensor system for use in, for instance, real-time detection and recognition of improvised explosive devices (“IEDs”) on fast moving vehicles for damage avoidance.

Applicant herein discloses a dual-sensor suite that may be used as a compliment, to use with prior art systems earth-penetrating radar sensors and systems.

In a first aspect of the invention, a sensor system is provided comprising at least one passive sensor element configured for imaging a scene of interest and outputting a passive sensor output that is representative of the scene of interest. A hyper-spectral or multi-spectral imaging system or LIDAR imaging system is provided that is configured for imaging the scene of interest and outputting a hyper-spectral or LIDAR output that is representative of the scene of interest.

One or both of the sensor systems may be disposed upon a user-controlled or electronic- or computer-controlled pan/tilt assembly. One or both of the sensor systems may be configured to operate in cooperation with an inertial measurement unit. An electronic synapse array may be provided in the first aspect that is configured to execute at least one algorithm for identifying a predefined feature in the scene using a combined set of passive sensor output data and hyper-spectral output data.

In a second aspect, of the invention, the synapse array may comprise a plurality of electronic neurons each comprising at least one synapse, connection, multiplication and addition circuit means, and storage means for storing and outputting a plurality of changing synapse weight inputs.

In a third aspect of the invention, selected ones of the synapses may have a time-dependent connectivity with selected other ones of the synapses by means of at least one time-dependent reconfigurable connection.

In a fourth aspect of the invention, at least one of the passive sensors is selected from, the group comprising a passive sensor having a responsivity to the visible electromagnetic spectrum, a sensor having a responsivity to the long wave infrared electromagnetic spectrum, a sensor having a responsivity to the short wave infrared electromagnetic spectrum, a sensor having a responsivity to the near-infrared electromagnetic spectrum and a sensor having a responsivity to the ultra-violet electromagnetic spectrum.

In a fifth aspect of the invention, an imaging sensor is provided comprising a stack of layers wherein the layers may comprise a micro-lens array layer comprising at least one individual lens element configured for providing a beam output, a photocathods layer configured for generating a photocathode electron output in response to a predetermined range of the electromagnetic spectrum, a micro-channel plate layer comprising at least one micro-channel for generating a cascaded electron output in response to the photocathode electron output, and, a readout circuit layer for processing the output of the micro-channel.

In a sixth aspect of the invention, the sensor system further comprises a cognitive sensor circuit comprising a first supertile and a second supertile. The first and second supertiles may comprise a plurality of tiles and further comprise a supertile processor, supertile memory and a supertile look up table. The first supertile is in electronic communication with the second supertile and the tiles comprise a plurality of cells and comprise a tile processor, tile memory and a tile look up table. Selected ones of the tiles may have a plurality of rile mesh outputs in electronic communication with an E, W, N and S neighboring tile of each of the selected tiles and with a supertile processor.

In a seventh aspect of the invention, the cells further comprise dedicated image memory and dedicated weight memory and convolution circuit means for performing a convolution kernel mask operation on an image data set that is representative of the scene. The image data may comprise the combined outputs of the passive sensor system and the hyper-spectral or LIDAR system. Selected ones of the cells have a plurality of cell mesh outputs in electronic communication with an E, W, N and S neighboring cell of the selected cells and a tile processor. A root processor circuit means may be provided for managing electronic communication between the cell mesh outputs, the tile mesh outputs or the supertile mesh outputs.

In an eighth aspect of the invention, a sensor system is disclosed comprising a first sensor configured for imaging a scene of interest and outputting a first sensor output representative of the scene of interest, a second sensor configured for imaging the scene of interest and outputting a second output representative of the scene of interest, and an electronic synapse array configured to execute at least one algorithm for identifying a predefined feature in a combined set of first sensor output data and second output data.

The preferred embodiment of the invention comprises a passive/visible, and SWTR wide-area search, sensor for providing a look-ahead capability with a partial resolution of about less than 1.0 cm at a search and acquisition range of about 300 m, operating in cooperation with an TED-recognition sensor operating with a plurality, e.g., 60, visible, hyper-spectral channels and comprising a UV flash laser providing a spatial resolution or about <0.1 cm having a capability of observing candidate IED sites from a standoff distance of ˜200 m. The disclosed sensor suite of the invention permits the detection of disturbed earth regions that necessarily exhibit slight spectral difference from adjacent regions.

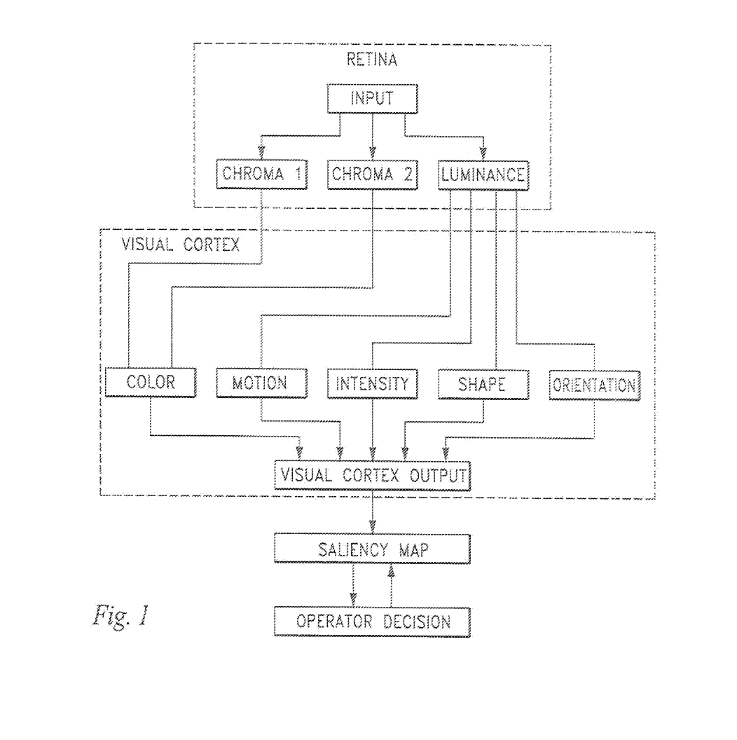

In the preferred embodiment, over about a six second period, data from the search multispectral sensor is processed in conjunction with radar observations whereby potential IED locations are identified and highlighted on an operator display using neural-inspired saliency processing techniques generally illustrated in the invention flowchart block diagram of FIG. 1.

Table 1 illustrates an exemplar IED mitigation timing for an armored vehicle traveling at 54 Km/hr (15 m/sec),

TABLE 1

| Event | Time (sec) | Range (meters) |
|---|---|---|
| Sensor Suite Initiates Target | t ≈ −16 sec | 300 m |
| Search Observations Ahead | | |
| of Vehicle | | |
| Search Sensor Mode Data | Δt ≈ 6 sec | 300 m → 200 m |
| Procession and Determination | (10 data frames) | |
| of Potential IED Locations | | |
| Operator Designates Potential | t ≈ −10 sec | 200 m |
| IED Locations for High | | |
| Resolution Observations | | |
| Recognition Sensor Mode | Δt ≈ −8 sec | 200 m → 100 m |
| Observations, Processing, and | | |
| Display of Potential IED | | |
| Locations | | |
| Operator Decision to Stop | t ≈ −2 sec | 100 m |
| Vehide | | |
| Vehicle Stop | t = 0 | 50 m |

The algorithmic approach of Table 1 has been successfully emulated in FPGA-based hardware at ISC8 Inc., assignee of the instant application, which approach is illustrated in the How diagram of a saliency algorithm architecture of FIG. 1.

Upon the identification and location of candidate IED sites, the very high resolution active-passive hyper-spectra, hyper-spatial recognition sensor of the invention is tasked to provide the operator with a hyper-resolution (<0.1 cm) image and with characterization of materials and surface conditions identified through hyper-spectral fingerprinting using stored lookup tables of known characteristics of the materials, surface conditions or other user defined data.

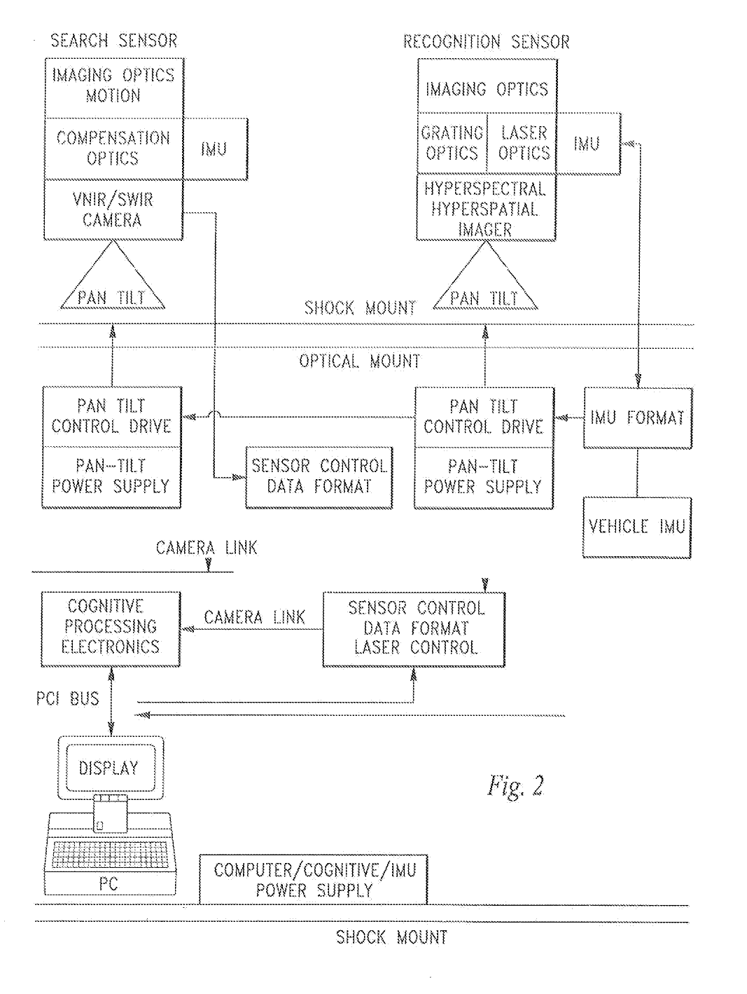

A block diagram of a preferred embodiment of the sensor suite of the invention, is shown, in FIG. 2.

The sensor suite comprises two major sensor elements, each with pan-and-tilt capability to perform a first search and second recognition function.

A single, combined visual/SWIR sensor provides a long-range search capability to establish Regions of Interest (ROIs) within a designated search area. These ROIs may be correlated with similar radar-determined ROIs. The designated search areas are digitally “marked” and segmented into progressively closer zones that provide a reference for the searching and marking process as the vehicle moves through successive search areas.

A combined UV laser/hyper-spectral sensor provides threat recognition in the ROIs and continuously processes added information as (be vehicle approaches each region, successively improving the quality of the feature recognition.

The pan-tilt tables are configured to allow the sensors to be scanned for search and are directed into the ROI scene for feature recognition. In addition, stabilizing mirrors are provided in the sensors to remove the high-frequency vibration/motion in the host vehicle and to provide the requisite internal scanning features required, by the hyper-spectral channel.

The sensors are preferably provided with and inertial measurement unit or “IMU” sensor to detect line of sight motion. Sensor data is formatted to camera link format prior to cognitive processing. The UV laser comprises beam-forming optics so the illumination beam substantially matches the field of view or “FOV” of the receiving camera element.

In addition to the increase in resolution, the receiver approach herein achieves a similar increase in sensitivity down to photon-counting levels by integrating micro-channel plate arrays with a >10⁵ gain into the system.

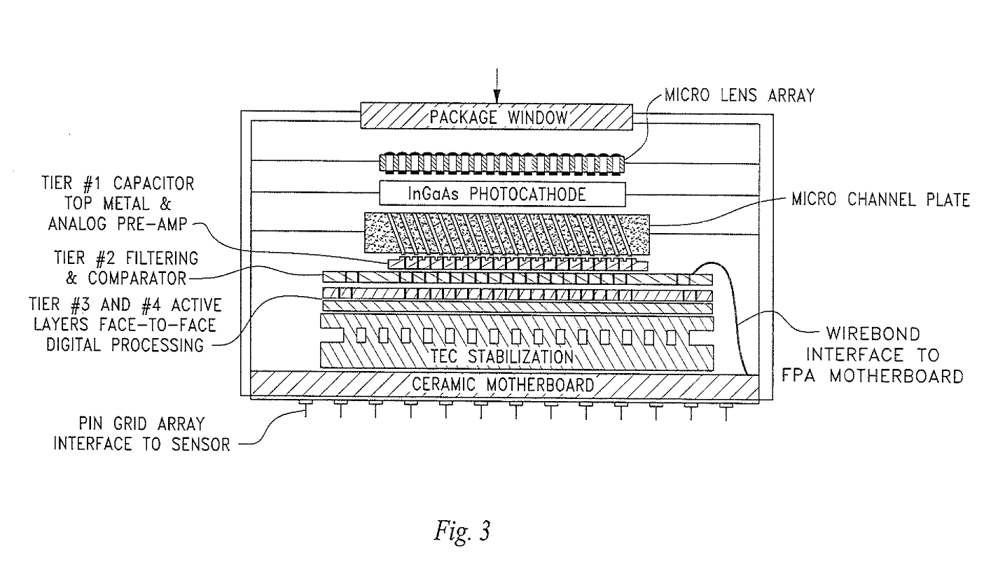

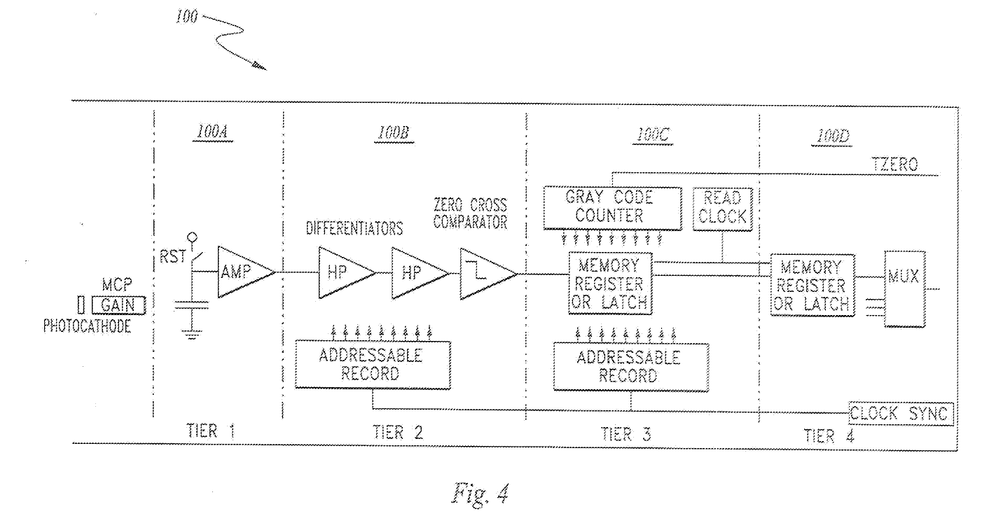

Such a receiver may incorporate the micro-channel plate array assembly and mufti-tiered ROIC of FIGS. 3 and 4 and which is disclosed in U.S. patent application Ser. No. 12/064,941, entitled “LIDAR. System Comprising Large Area Micro-Channel Plate Focal. Plane Array”, to Azzazy et al, now pending and the entire contents of which are incorporated herein by reference.

Table 2 presents a set of preferred instantaneous fields of view or “IFOVs” of a sensor suite of the invention

TABLE 2

| | |
|---|---|
| SWIR Search | 20 micro-radians |
| Visible Search | 10 micro-radians |
| Visible Hyper-spectral | 10 micro-radians |
| Active UV Recognition | 5 micro-radians |

The system processing hardware of the invention receives inputs via the search sensor imaging channel. Data from the arrays are deblurred in a first processing step and registered and sent to the processor to extract saliency maps corresponding to points of interest in the scene in a second processing step.

The coordinates of the salient locations in the map are converted from image coordinates to world coordinates and sent to a gimbal control to direct the hyper-spectral and active sensors. The hyper-spectral output is also deblurred and registered band-by-band before sending to the interpretive processor for scene element characterization.

The active output does not require deblurring as it is a single-flash staring array with a very short exposure time. The system operator is cued using video overlays with world coordinates of the target ROIs as they are observed and as the scene characteristics are determined.

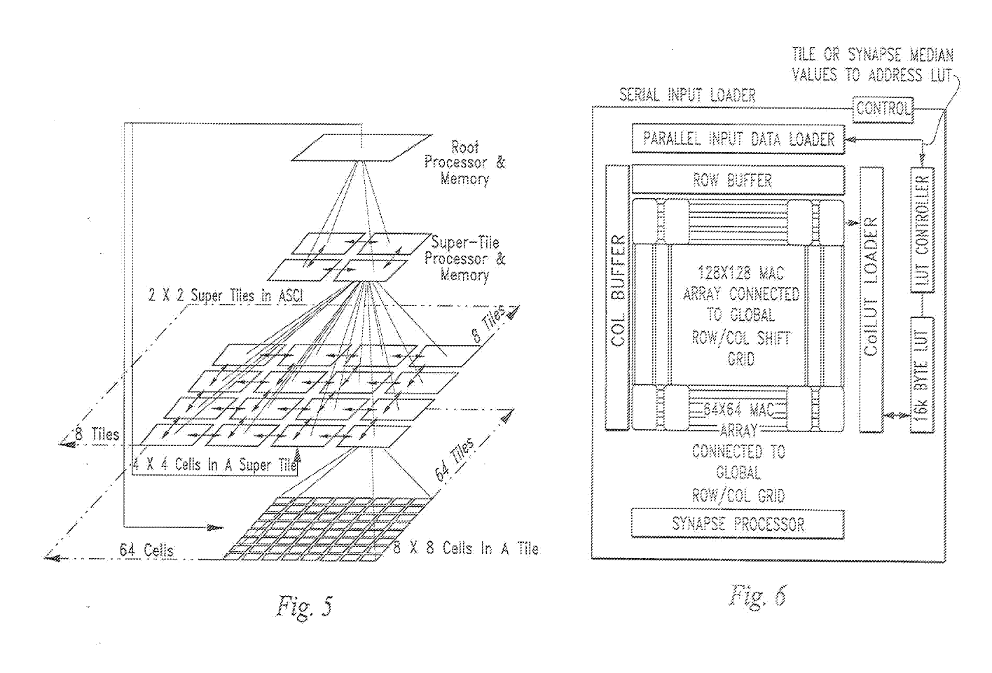

Image deblurring and registration is performed using a COTS processor whereas saliency and target recognition data is computed using a neuromorphic computing element such as by using the image processor application specific integrated circuit or “ASIC” design of FIGS. 5 and 6, as is disclosed in U.S. patent application Ser. No. 12/661,537, “Apparatus Comprising Artificial Neuronal Assembly”, now allowed and assigned to ISC8 Inc., assignee of the instant application, the entire contents of which is incorporated herein by reference.

With prior knowledge in the form of data look up tables storing predefined sets of image characteristics, the algorithms being executed in the neuromorphic computing element can be “tuned” top-down to detect and identify specific features or signatures that describe targets of interest; e.g. object sticking out of the ground of certain shapes and sizes.

Saliency processing operates by calculating several output feature data streams from an input video data stream. Examples may include specific size and orientation features, intensity features, color features, spatial textures, shape features, or any user defined sets of image characteristic data or feature.

Once the predefined features are computed and identified, they may be “parsed” by a visual cortex image processing module configured to calculate saliency maps based, for instance, on weights and preferences given to the different saliency channels including the top-down attention channel which algorithms are configured to specify what to look for in mathematical terms.

The saliency maps may then be sent (in world coordinates) to the gimbal control element of the invention so that the hyper-spectral and active sensors configured for a higher video resolution “foveation” of the identified regions of interest. The outputs are then processed similarly using a multi-spectral or hyper-spectral version of the algorithm.

Depending upon the operational scenario, the user may be cued to the presence of a potential threat object based on the generated saliency map.

In the preferred embodiment of the invention, the raw data processing load for the cognitive process of the invention may be estimated from the FPA pixel count and sample rates of the search and recognition sensor channels. The visible search and the infrared search channels may produce for instance, 400 and 100 megapixels per sec. in each channel when operated at 1 Hz. (i.e., 20K×20K visible pixels and 10K×10K SWIR pixels).

The 2-D laser imager of the system produces five megapixels per see, when operated at 5 Hz. The hyper-spectral sensor produces 78.5 megapixels per sec, when operated at 5 Hz. Thus the system of the preferred embodiment, at full load, is producing samples at about a 583.5 megapixels per see rate.

The operation of the sensor suite of the invention relies on providing a long range (e.g., 300 meters) search sensor suite that operates in full-light and low-light levels and provides high-resolution imagery which is processed in real-time to identity potential. IED locations.

This search and recognition function desirably operates as a compliment to the earth-penetrating radar system operations to achieve lower false alarm rates through correlation of radar detection with measurements of associated disturbed earth conditions. This is followed by use of hyper-resolution, active and passive sensors for IED recognition. A key feature is to maintain critical operator interface and final-action decision authority.

Candidate IED locations are identified to the operator by highlighted display of the search sensor imagery. The operator designates which of these locations to subject to further observation with the recognition sensor suite. After ROI examination with the active-passive recognition sensors of the invention, the hyper-resolution imagery and results of hyper-spectral fingerprinting is displayed to the operator who then makes a decision to stop the vehicle or proceed on with the mission. Detection and recognition ranges, processing times, and decision points are managed to insure the vehicle remains out of harm's way to the maximum extent possible.

At least two innovations are provided in the sensor suite of the invention. The first, is an advanced concept in a 3D LIDAR detector and read-out architecture which allows a reduction in detector size, leading to much larger number of detector channels to be packaged in practical arrays.

As discussed above, the sensor suite produces a “flood” of image data which must be processed, interpreted, and displayed very last to support real-time operations. This requirement is met by incorporating the above-cited invention of U.S. patent application Ser. No. 12/661,537, “Apparatus Comprising Artificial Neuronal Assembly” that, in an exemplar embodiment, is capable of performing 2 TeraOps/sec, for a power bad of <10 watts in a single small chip.

Table 3 is a set of exemplar specifications for a preferred embodiment of a sensor suite of the invention.

TABLE 3

| | SEARCH | | RECOGNITION | |
|---|---|---|---|---|
| | VNIR | SWIR | Hyper-spectral | Hyper-spatial |
| Aperture | 15 cm | 15 cm | 15 cm | 15 cm |
| Spectral Range | 0.5-1.0 μm | 1.3-2.5 μm | 0.6-0.75 μm | 0.2-0.3 μm |
| Spectral | — | — | 10 nm | 0.1 nm |
| Resolution | | | | |
| Type | scanner | scanner | step-stare | step-stare |
| IFOV | 10 μrad | 20 μrad | 10 μrad | 5 μrad |
| FOV | Az 5°; EL 0.02° | Az 5°: EL 0.02° | .15 deg × .15 deg | .15 deg × .15 deg |
| Frame Size | 10° × 10° | 10° × 10° | .15 deg × .15 deg | .15 deg × .15 deg |
| Pixels/Frame | 20K × 20K | 10K × 10K | 512 × 512 | 1K × 1K |
| FOR | Az 120°; EL 10° | Az 120°; EL 10° | Az 120°; EL 10° | Az 120°; EL 10° |
| Frames/sec | 1 | 1 | 5 | 5 |
| FPA Size | 5K × 32 (TDI) | 2.5K × 32 (TDI) | 512 × 512 | 1K × 1K |

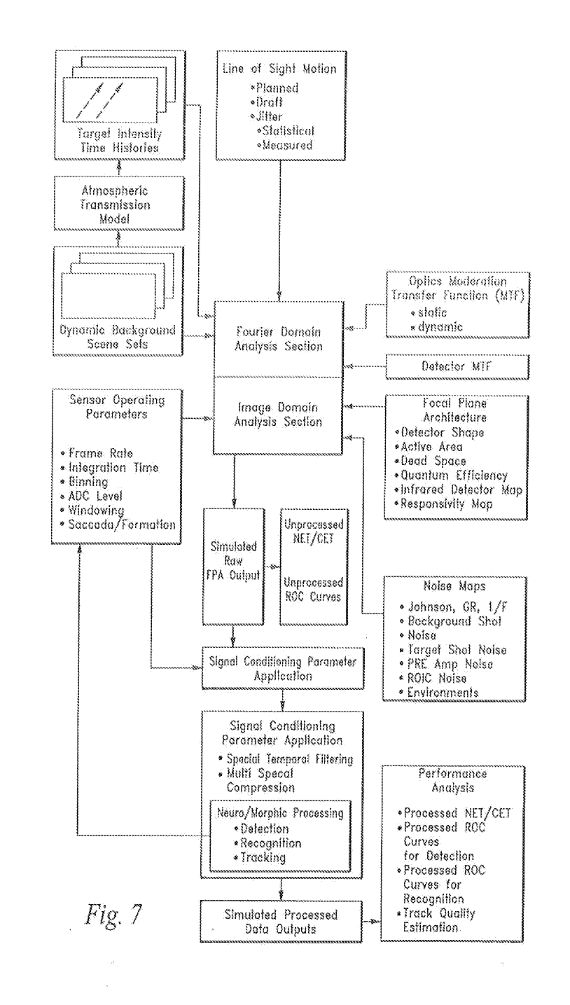

The invention may be facilitated by high fidelity passive and active sensor simulation/emulation methods as shown in FIG. 7. Exemplar sensor systems emulated using the method of FIG. 7 include, for instance, a visible hyper-spectral sensor developed for the U.S. Navy for buried mine detection in littoral water/beach areas, and 3D imaging LIDAR systems developed for tactical and space applications.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim.

Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. A sensor system comprising:
at least one passive sensor configured for imaging a scene of interest and outputting a passive sensor output representative of the scene,
a hyper-spectral imaging system configured for imaging the scene and outputting a hyper-spectral output representative of the scene,
an electronic synapse array configured to execute at least one algorithm for identifying a predefined feature in the scene in a combined set of passive sensor output data and hyper-spectral output data.

2. The system of claim 1 wherein the array comprises a plurality of electronic neurons each comprising at least one synapse connection, multiplication and addition circuit means, and storage means for storing and outputting a plurality of changing synapse weight inputs.

3. The system of claim 1 wherein selected ones of the synapses have a time-dependent connectivity with selected other ones of the synapses by means of at least one time-dependent reconfigurable connection.

4. The system, of claim 1 wherein at the least one passive sensor is selected from the group comprising a passive sensor having a responsivity to the visible electromagnetic spectrum, a passive sensor having a responsivity to the long wave infrared electromagnetic spectrum, a passive sensor having a responsivity to the short wave infrared electromagnetic spectrum, a passive sensor having a responsivity to the near-infrared electromagnetic spectrum and a passive sensor having a responsivity to the ultra-violet electromagnetic spectrum.

5. The system of claim 1 further comprising an imaging sensor comprising a stack of layer's wherein the layers comprise a micro-lens array layer comprising at least one individual lens element configured for providing a beam output,
a photocathode layer configured for generating a photocathode electron output in response to a predetermined range of the electromagnetic spectrum,
a micro-channel plate layer comprising at least one micro-channel for generating a cascaded electron output in response to the photocathode electron output and,
a readout circuit layer for processing the output of the micro-channel.

6. The system of claim 1 further comprising a cognitive sensor circuit comprising a first supertile and a second supertile,
the first and second supertiles comprising a plurality of tiles and comprising a supertile processor, supertile memory and a supertile look up table,
the first supertile in electronic communication with the second supertile,
the tiles comprising a plurality of cells and comprising a tile processor, tile memory and a file look up table,
selected ones of the tiles having a plurality of tile mesh outputs in electronic communication with an E, W, N and S neighboring tile of each of the selected tiles and with a supertile processor.

7. The system of claim 6 wherein the cells further comprise dedicated image memory and dedicated weight memory and convolution circuit means for performing a convolution kernel mask operation on an image data set representative of the scene, and,
wherein selected ones of the cells having a plurality of cell mesh outputs in electronic communication with an E, W, N and S neighboring cell of the selected cells and a tile processor, and,
root processor circuit means for managing electronic communication between the cell mesh outputs, said tile mesh outputs or the supertile mesh outputs.

8. A sensor system comprising:
a first sensor configured for imaging a scene of interest and outputting a first sensor output representative of the scene,
a second sensor configured for imaging the scene of interest and outputting a second output representative of the scene, and,
an electronic synapse array configured to execute at least one algorithm for identifying a predefined feature in the scene in a combined set of first sensor output data and second output data.

9. The system of claim 8 wherein the array comprises a plurality of electronic neurons each comprising at least one synapse connection, multiplication and addition circuit means, and storage means for storing and outputting a plurality of changing synapse weight inputs.

10. The system of claim 8 wherein selected ones of the synapses have a time-dependent connectivity with selected other ones of the synapses by means of at least one time-dependent reconfigurable connection.

11. The system of claim 8 further wherein at least one of the first or second sensors comprises a stack of layers wherein the layers comprise a micro-lens array layer comprising at least one individual lens element configured for providing a beam output,
a photocathode layer configured for generating a photocathode electron output in response to a predetermined range of the electromagnetic spectrum,
a micro-channel plate layer comprising at least one micro-channel for generating a cascaded electron output in response to the photocathode electron output, and,
a readout circuit layer for processing the output of the micro-channel.

12. The system of claim 8 further comprising a cognitive sensor circuit comprising a first supertile and a second supertile,
the first and second supertiles comprising a plurality of tiles and comprising a supertile processor, supertile memory and a supertile look up table,
the first supertile in electronic communication with the second supertile,
the tiles comprising a plurality of cells and comprising a tile processor, tile memory and a tile look up table, and,
selected ones of the tiles having a plurality of tile mesh outputs in electronic communication with an E, W, N and S neighboring tile of each of the selected tiles and with a supertile processor.

13. The system of claim 12 wherein the cells further comprise dedicated image memory and dedicated weight memory and convolution circuit means for performing a convolution kernel mask operation on an image data set representative of the scene, and,
wherein selected ones of the cells having a plurality of cell mesh outputs in electronic communication with an E, W, N and S neighboring cell of the selected cells and a tile processor, and,
root processor circuit means for managing electronic communication between the cell mesh outputs, said tile mesh outputs or the supertile mesh outputs.
